(19) United States
(12) Patent Application Publication
(10) Pub. No.: US 2001/0027716 A1
(43) Pub. Date: Oct. 11, 2001

(54) Pickup for electric guitars

(76) Inventor: William T. Turner, Chino Hills, CA (US)

Correspondence Address: STRADLING YOCCA CARLSON & RAUTH, IP Department, 660 Newport Center Drive, Suite 1600, P.O. Box 7680, Newport Beach, CA, 92660-6441, US

(21) Appl. No.: 09/825,918

(22) Filed: Apr. 3, 2001

Related U.S. Application Data
(62) Division of application No. 09/014,839, filed on Jan. 28, 1998.

(51) Int. Cl. G10H 3/18

(52) U.S. Cl. 84/726

(57) ABSTRACT

A guitar pickup has symmetrically balanced coils arranged in a concentric configuration with a ferromagnetic steel plate centrally common to both coils. Inductive components are added or subtracted in order to enhance the sound and tonal characteristics that pickup without compromising noise immunity. A non-magnetized planar ferromagnetic plate is interposed between upper and lower coils of the pickup. Magnetic pole pieces extend from within the upper coil to within the lower coil through holes disposed in the planar ferromagnetic plate.

### CROSS-REFERENCE TO RELATED APPLICATIONS

This application is a divisional of patent application Ser. No. 09/014,839, filed Jan. 28, 1998 on which this application claims priority under 35 U.S.C. § 120.

### BACKGROUND OF THE INVENTION

It is well known that a pickup consisting of a single monolithic coil will pick up stray electromagnetic radiation and transmit this radiation (when coupled to a musical instrument amplifier) in the form of noise, which is audible as low frequency 60 HZ hum. There is also electrostatic noise, in the form of high frequency buzzing, at the pickup's resonant peak frequency. By combining a pair of coils as employed in the humbucking pickup principle, the audible noise factor is considerably reduced but not completely eliminated. As shown in U.S. Pat. No. 4,442,749, the humbucking principle can be applied in a pickup with the coils arranged in a concentric configuration, with a metal plate formed into a U shaped channel common only to the upper coil section of the pickup. This configuration is inductively unbalanced, which compromises the noise reduction capability of the pickup.

### SUMMARY OF THE INVENTION

The present invention in one of its aspects has symmetrically balanced coils arranged in a concentric configuration, with a ferromagnetic steel plate centrally common to both coils; it incorporates the humbucking pickup principle for maximum noise immunity.

There is an improved means for increasing the volume of magnetic flux through the coils of the pickup, which correspondingly increases the output voltage and signal amplitude of the pickup.

There is an improved means for adding or subtracting inductive components to enhance the sound and tonal characteristics of the pickup, without compromising noise immunity.

There is an improved means for incorporating magnetic pole pieces of varying length in the pickup to control the output, balance, and sensitivity for varying diameter musical strings.

There is an improved means for increasing isolation between the pickup coils to reduce phase cancellation of common frequencies, which allows the pickup to exhibit an improved harmonic content for richer sound and tonal quality.

### BRIEF DESCRIPTION OF THE DRAWINGS

FIG. 1 is a top plan view of an electromagnetic pickup embodying the present invention;

FIG. 2 is a view, the right half of which is in side elevation and the left half of which is in vertical central section, of the pickup; and

FIG. 3 is an end elevation as viewed from the right in FIG. 1, the coils being unshown.

### DETAILED DESCRIPTION OF THE PREFERRED EMBODIMENT

The illustrated embodiment is symmetrical about a vertical plane that is perpendicular to the longitudinal axis of the pickup and that is midway between the ends of the pickup.

The illustrated pickup is for a six-string electric guitar.

The core assembly of the pickup comprises an upper bobbin section, a centrally located ferromagnetic steel plate, and a lower bobbin section. Fastening screws, of ferromagnetic material, are inserted through the bobbin core at the base of the lower bobbin section. The fastening screws extend upward from the lower bobbin section. A central steel plate is provided with corresponding apertures to engage the fastening screws. The fastening screws may pass through the apertures in the plate, the apertures in the plate being of a greater diameter than the major diameter of the screw. The plate engages the upper planar surface of the lower bobbin section.

The fastening screws extend upward through the plate to receive the upper bobbin section. The upper bobbin section engages the plate at the lower planar surface of the upper bobbin section. The screws are then fastened into the upper bobbin section, coupling the upper and lower bobbin sections together with the plate interposing the upper face section of the lower bobbin and the lower face section of the upper bobbin.

Each bobbin section has a plurality of circular apertures which extend and align through the central core of the upper and lower bobbin sections to receive a plurality of corresponding rod type magnetic pole pieces. The plate has a plurality of corresponding circular apertures which align with the circular apertures in the upper and lower bobbin sections.

The circular apertures in the plate have a plurality of smaller apertures adjacent to the circular apertures for the purpose of receiving the fastening screws and additional ferromagnetic steel pole pieces.

The magnetic pole pieces are of sufficient length to extend fully through the upper and lower bobbin sections.

The magnetic pole pieces are flush at the base of the lower bobbin section and extend upwardly through the upper bobbin, projecting a short distance above the upper bobbin section surface, being positioned above the upper bobbin surface in an echelon arrangement.

The pickup shown in the drawings comprises an upper bobbin 10, a lower bobbin 11, six permanent magnet pole pieces 12, screws 13, upper and lower windings 14 and 15, and a ferromagnetic steel plate 17.

Upper bobbin 10 and lower bobbin 11 are formed of nonmagnetic material and nonmagnetizable material, preferably a synthetic resin. Upper bobbin 10 has upper and lower plates between which the upper winding is wound in a particular direction, for example clockwise as viewed from above. These plates are identical to each other in the illustrated embodiment, although this is not necessary. Lower bobbin 11 has upper and lower plates also parallel to each other, the upper plate in the preferred form being much larger than the lower and forming a skirt which is used for mounting purposes. The upper and lower plates of upper bobbin 10 are numbered 18 and 19, respectively. The skirt plate and lower plate of lower bobbin 11 are numbered 20 and 21, respectively.

The six permanent magnet pole pieces 12a, 12b, 12c, 12d, 12e, 12f are mounted parallel to each other in registered holes in upper and lower bobbins 10 and 11, as shown. The magnetic poles of the pole pieces correspond to each other. Thus, for example, all of the north poles are uppermost and all of the south poles are lowermost.

The steel screws 13 are secured in internally threaded holes in the upper and lower bobbins 10,11, and not only hold the bobbins together with each other and with the ferromagnetic steel plate, but also alter the inductance of the pickup. Thus, they serve two purposes.

There are holes 23 in the bobbins, between pole pieces 12b and 12c, and 12d and 12e.

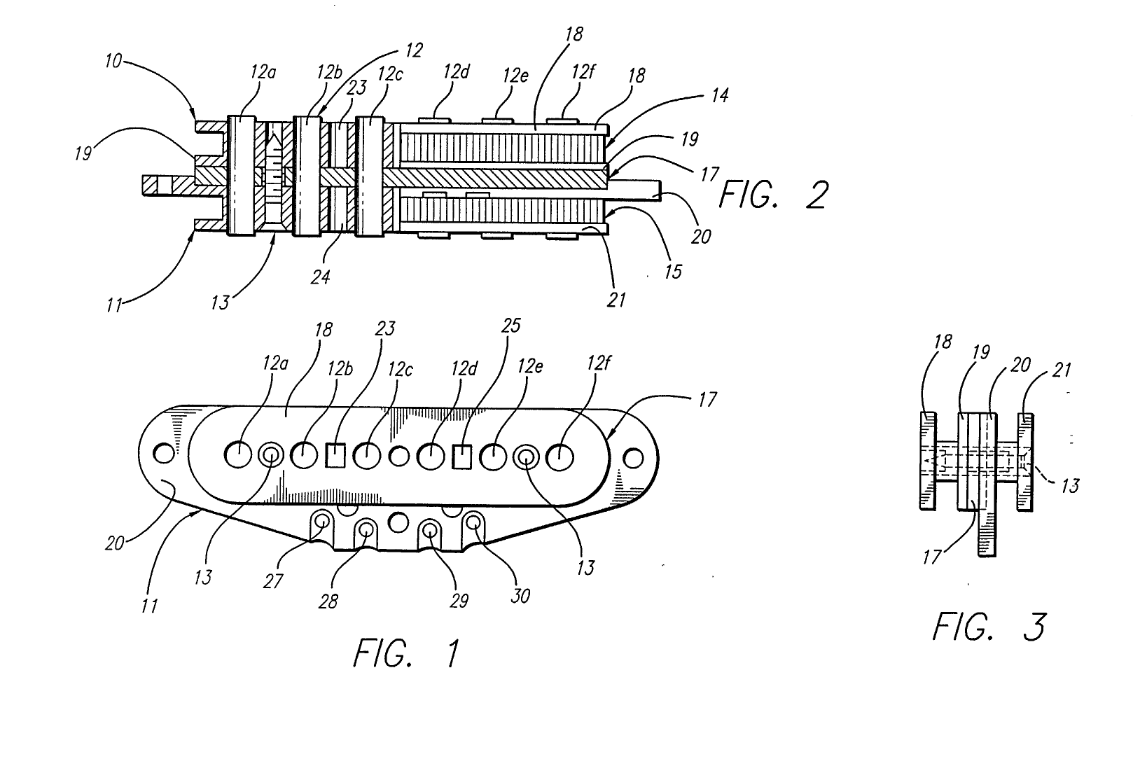

There are connections (FIG. 1) 27,28,29 and 30. Two of these serve the upper coil or winding 14, and the other two serve the lower winding 15. The lower winding is wound in the opposite direction from the upper, for example counterclockwise in the illustration. Thus, there is the humbucking effect.

The ferromagnetic steel plate 17 is sandwiched between plates 19 and 20 and parallel thereto, being formed of magnetizable material. Stated more definitely, element 17 is a ferromagnetic steel plate. The steel plate has clearance holes therethrough to receive the pole pieces and the screws.

It is to be understood that ferromagnetic cylinders may be inserted in the holes 23,24 in order to change the inductance of the pickup. These may be changed in accordance with the desires of the musician. Stated otherwise, there may be cylinders in some holes or openings 23,24 and not in others.

The foregoing detailed description is to be clearly understood as given by way of illustration and example only, the spirit and scope of this invention being limited solely by the appended claims.

What is claimed is:

1. [Canceled.]

2. A pickup comprising:
an upper coil;
a lower coil;
a non-magnetized planar ferromagnetic plate interposed between said upper and lower coils, said plate having at least one opening; and
a magnetic pole piece extending from the upper coil to the lower coil through said opening in the planar ferromagnetic plate.

3. The pickup of claim 2, wherein said upper coil is wounded around an upper bobbin.

4. The pickup of claim 2, wherein said lower coil is wounded around a lower bobbin.

5. The pickup of claim 2, wherein the ends of said ferromagnetic plate terminates above the lower coil.

6. The pickup of claim 2, wherein the ferromagnetic plate includes steel.

7. The pickup of claim 2, further including a plurality of magnetic pole pieces extending from the upper coil to the lower coil.

8. The pickup of claim 2, wherein the magnetic pole piece extends above the upper coil.

9. A pickup comprising:
an upper coil;
a lower coil;
a non-magnetized planar ferromagnetic plate interposed between said upper and lower coils, said planar ferromagnetic plate having at least one hole therethrough; and
a magnetic pole piece extending from above the upper coil to below the lower coil through said hole of the planar ferromagnetic plate.

10. The pickup of claim 9, further including an upper bobbin to which the upper coil is wound around, and a lower bobbin to which the lower coil is wound around.

11. The pickup of claim 10, further including ferromagnetic screws for securing said upper bobbin, ferromagnetic plate, and said lower bobbin in a stacked arrangement.

12. The pickup of claim 11, wherein said ferromagnetic screws include steel.

13. The pickup of claim 9, further including at least one ferromagnetic cylinder situated within said upper coil.

14. The pickup of claim 9, further including a plurality of magnetic pole pieces extending from above the upper coil to below the lower coil through respective holes in the planar ferromagnetic plate.

15. The pickup of claim 9, wherein the ferromagnetic plate includes steel.

16. A pickup comprising:
an upper coil;
a lower coil;
a non-magnetized planar ferromagnetic plate interposed between said upper and lower coils, said planar ferromagnetic plate having at lest one hole therethrough; and
a magnetic pole piece extending from within the upper coil to within the lower coil through said hole of the planar ferromagnetic plate.

17. The pickup of claim 16, further including an upper bobbin to which the upper coil is wound around, and a lower bobbin to which the lower bobbin is wound around.

18. The pickup of claim 17, further including ferromagnetic screws for securing said upper bobbin, ferromagnetic plate, and said lower bobbin in a stacked arrangement.

19. The pickup of claim 18, wherein said ferromagnetic screws include steel.

20. The pickup of claim 16, further including at least one ferromagnetic cylinder situated within said upper coil.

21. The pickup of claim 16, further including a plurality of magnetic pole pieces extending from above the upper coil to below the lower coil through respective holes of the planar ferromagnetic plate.
